(19) United States
(12) Patent Application Publication
(10) Pub. No.: US 2010/0131096 A1
(43) Pub. Date: May 27, 2010

(54) Free Sample Distributing System, Free Sample Distributing Device, Free Sample Distribution Information Server, Free Sample Distributing Method, Free Sample Distributing Information Processing Program and Computer Readable Medium

(75) Inventor: Takeshi Koyano, Tokyo (JP)

Correspondence Address: RABIN & Berdo, PC, 1101 14TH STREET, NW, SUITE 500, WASHINGTON, DC, 20005, US

(73) Assignee: OKI ELECTRIC INDUSTRY CO., LTD., Tokyo (JP)

(21) Appl. No.: 12/452,569

(22) PCT Filed: May 1, 2008
(86) PCT No.: PCT/JP2008/058349

§ 371 Date: Jan. 8, 2010

(30) Foreign Application Priority Data
Jul. 11, 2007 (JP) 2007-182163

(51) Int. Cl. G07F 7/00; G06F 17/00; G06F 15/16

(52) U.S. Cl. 700/236; 700/237; 709/204

(57) ABSTRACT

A free sample distributing system comprises a plurality of free sample distributing devices and a free sample distribution information server. Each free sample distributing device imports identification information of a user desiring acquisition of a free sample, and sends the identification information to the free sample distribution information server. The free sample distribution information server decides a type of a free sample to be provided for the user, by searching a user information storage unit, by recognizing personal information of the user pertaining to the identification information, and by comparing the personal information with the free sample distribution conditions of free sample types. The free sample distributing device dispenses the free sample of the decided type from a housing unit and provides the user with the free sample.

### TECHNICAL FIELD

The present invention relates to a free sample distributing system, a free sample distributing device, a free sample distribution information server, a free sample distributing method, a free sample distribution information processing program and a computer-readable medium and particularly relates to making it possible to more reliably provide free samples to users intended by the distribution side.

### BACKGROUND ART

There have already been proposed a free sample distributing device and a free sample distributing system that distribute free samples to users without reliance on human hands.

In the free sample distributing system described in JP-A No. 2006-227815, sampling boxes that are installed in plural locations used by the general public and house one type of free sample and a server device are communicably connected to each other via a network. When personal information of a user who wants to acquire a free sample is inputted to the server device, the server device issues identification information for acquiring the free sample and stores the inputted personal information in a personal information database. When the identification information is inputted to the sampling boxes, the sampling boxes perform authentication and distribute the free sample.

Further, the free sample providing system described in JP-A No. 2006-163486 is equipped with an authentication medium carried by customers, a free sample provision managing device that determines whether or not to provide a free sample on the basis of free sample provision determination information associated with identification information stored in this authentication medium, and an automated vending machine that supplies the free sample free of charge with respect to customers who have a need and have been determined to be allowed provision of the free sample by this free sample provision managing device.

### DISCLOSURE OF INVENTION

### Problem To Be Solved By Invention

However, with conventional methods, it is not possible to deliver free samples to users who have no interest and elicit new interest with free samples from users who have no interest.

Further, when it is not intended for a user who does not fit a free sample distribution target to become a distribution target, it is not possible to deliver a free sample even if there is a free sample distribution target around that user (e.g., family members).

Moreover, although it is preferable to have many items of personal information to narrow down a free sample distribution target, it is conceivable that there will also be many users who will not perform registration operation when they are made to input many items. Further, when the number of items of personal information is kept low, it becomes difficult for a company to appropriately narrow down the distribution target.

For that reason, there are desired a free sample distributing system, a free sample distributing device, a free sample distribution information server, a free sample distributing method, a free sample distribution information processing program and a computer-readable medium that can more reliably provide free samples to users intended by the distribution side.

### Solution to the Problem

According to a first aspect of the present invention, a free sample distributing system includes a plurality of free sample distributing devices and a free sample distribution information server, (1) each of the free sample distributing devices comprises (1-1) a housing unit that houses plural types of free samples such that they are respectively dischargeable, (1-2) a user identification information importing unit that imports, and transmits to the free sample distribution information server, identification information of a user who wants to acquire a free sample, and (1-3) a free sample providing unit that dispenses from the housing unit and supplies to the user a type of free sample that has been instructed from a free sample distribution information server, and (2) the free sample distribution information server comprises (2-1) a user information storing unit that stores personal information of a user to whom it is allowed to provide a free sample in association with identification information of the user, (2-2) a free sample distribution condition storing unit that stores free sample distribution conditions configured by combinations of item contents of the personal information that are determined in regard to the respective types of the free samples, and (2-3) a provided free sample type deciding unit which, when identification information of a user has been transmitted thereto from any of the free sample distributing devices, searches the user information storing unit, recognizes personal information of the user pertaining to the identification information, and compares the personal information with the free sample distribution conditions stored in the free sample distribution condition storing unit to thereby obtain a free sample distribution condition that becomes established in regard to the user, and instructs the free sample distributing device from which the identification information of the user was transmitted to provide a type of free sample pertaining to the established free sample distribution condition.

According to a second aspect of the present invention, a free sample distribution information server configures a free sample distributing system together with a plurality of free sample distributing devices, each of which includes a housing unit that houses plural types of free samples such that they are respectively dischargeable, a user identification information importing unit that imports and transmits identification information of a user who wants to acquire a free sample and a free sample providing unit that dispenses from the housing unit and supplies to the user a type of free sample that has been instructed, the free sample distribution information server, the server includes: (1) a user information storing unit that stores personal information of user to whom it is allowed to provide a free sample in association with identification information of the user; (2) a free sample distribution condition storing unit that stores free sample distribution conditions configured by combinations of item contents of the personal information that are determined in regard to the respective types of the free samples; and (3) a provided free sample type deciding unit which, when identification information of a user has been transmitted thereto from any of the free sample distributing devices, searches the user information storing unit, recognizes the personal information of the user pertaining to the identification information, and compares the personal information with the free sample distribution conditions stored in the free sample distribution condition storing unit to thereby obtain a free sample distribution condition that becomes established in regard to the user, and instructs the free sample distributing device from which the identification information of the user was transmitted to provide a type of free sample pertaining to the established free sample distribution condition.

According to a third aspect of the present invention, a free sample distributing device includes: a housing unit that houses plural types of free samples such that they are respectively dischargeable; a user identification information importing unit that imports, and transmits to a free sample distribution information server, identification information of a user who wants to acquire a free sample; a free sample providing unit that dispenses from the housing unit and supplies to the user a type of free sample that has been instructed from the free sample distribution information server; a question asking unit that asks a question in regard to an item that has been instructed from the free sample distribution information server in regard to a user who is already initially registered in the free sample distribution information server; and a responding unit that imports, and sends back to the free sample distribution information server, a response from the user with respect to the question.

According to a fourth aspect of the present invention, a method of distributing a free sample in a free sample distributing system comprising a plurality of free sample distributing devices and a free sample distribution information server, wherein (1) each of the free sample distributing devices comprises a housing unit that houses plural types of free samples such that they are respectively dischargeable, a user identification information importing unit, and a free sample providing unit, (2) the free sample distribution information server comprises a user information storing unit that stores personal information of a user to whom it is allowed to provide a free sample in association with identification information of the users, a free sample distribution condition storing unit that stores free sample distribution conditions configured by combinations of item contents of the personal information that are determined in regard to the respective types of the free samples, and a provided free sample type deciding unit, the method includes (3-1) the user identification information importing unit importing, and transmitting to the free sample distribution information server, identification information of a user who wants to acquire a free sample, (3-2) when identification information of a user has been transmitted to the provided free sample type deciding unit from any of the free sample distributing devices, the provided free sample type deciding unit searching the user information storing unit, recognizing personal information of the user pertaining to the identification information, and comparing the personal information with the free sample distribution conditions stored in the free sample distribution condition storing unit to thereby obtain a free sample distribution condition that becomes established in regard to the user, and instructing the free sample distributing device from which the identification information of the user was transmitted to provide a type of free sample pertaining to the established free sample distribution condition, and (3-3) the free sample providing unit dispensing from the housing unit and supplying to the user a type of free sample that has been instructed from the free sample distribution information server.

According to a fifth aspect of the present invention, a computer-readable medium stores a program that causes free sample distribution information processing to be executed in a computer that constructs a free sample distribution information server that configures a free sample distributing system together with a plurality of free sample distributing devices, each of the plurality of free sample distributing devices comprises a housing unit that houses plural types of free samples such that they are respectively dischargeable, a user identification information importing unit that imports and transmits identification information of a user who wants to acquire a free sample, and a free sample providing unit that dispenses from the housing unit and supplies to the user a type of free sample that has been instructed, the free sample distribution information processing including: (1) storing personal information of a user to whom it is allowed to provide a free sample in association with identification information of the user; (2) storing free sample distribution conditions configured by combinations of item contents of the personal information that are determined in regard to the respective types of the free samples; and (3) when identification information of a user has been transmitted from any of the free sample distributing devices, searching the stored personal information, recognizing the personal information of the user pertaining to the identification information, and comparing the personal information with the stored free sample distribution conditions to thereby obtain a free sample distribution condition that becomes established in regard to the user, and instructing the free sample distributing device from which the identification information of the user was transmitted to provide a type of free sample pertaining to the established free sample distribution condition.

According to a sixth aspect of the present invention, a free sample distribution information processing program is installed in a computer that constructs a free sample distribution information server that configures a free sample distributing system together with a plurality of free sample distributing devices, each of the plurality of free sample distributing devices comprises a housing unit that houses plural types of free samples such that they are respectively dischargeable, a user identification information importing unit that imports and transmits identification information of a user who wants to acquire a free sample, and a free sample providing unit that dispenses from the housing unit and supplies to the user a type of free sample that has been instructed, the free sample distribution information processing including: (1) storing personal information of a user to whom it is allowed to provide a free sample in association with identification information of the user; (2) storing free sample distribution conditions configured by combinations of item contents of the personal information that are determined in regard to the respective types of the free samples; and (3) when identification information of a user has been transmitted from any of the free sample distributing devices, searching the stored personal information, recognizing the personal information of the user pertaining to the identification information, and comparing the personal information with the stored free sample distribution conditions to thereby obtain a free sample distribution condition that becomes established in regard to the user, and instructing the free sample distributing device from which the identification information of the user was transmitted to provide a type of free sample pertaining to the established free sample distribution condition.

### Effect of the Invention

According to the present invention, it becomes possible to more reliably provide free samples to users intended by the distribution side.

### BRIEF DESCRIPTION OF DRAWINGS

FIG. 1 is a block diagram showing the overall configuration of a free sample distributing system pertaining to a first embodiment;

FIG. 2 is a general front view of a free sample distributing device in the first embodiment;

FIG. 3 is a block diagram showing the functional configuration of the free sample distributing device in the first embodiment;

FIG. 4 is a block diagram showing the functional configuration of a free sample distribution information server in the first embodiment;

FIG. 5 is an explanatory diagram showing a configural example of a personal information accumulating unit in the free sample distribution information server of the first embodiment;

FIG. 6 is a sequence diagram showing operation when a user registers personal information in the free sample distributing system of the first embodiment;

FIG. 7 is a sequence diagram showing operation when dispatching an email message notifying users of the provision of a new free sample in the free sample distributing system of the first embodiment;

FIG. 8 is a sequence diagram (first half) showing operation when providing a free sample to a user in the free sample distributing system of the first embodiment;

FIG. 9 is a sequence diagram (second half) showing operation when providing a free sample to a user in the free sample distributing system of the first embodiment;

FIG. 10 is a sequence diagram showing part of operation when providing a free sample to a user in a free sample distributing system of a second embodiment; and

FIG. 11 is a sequence diagram showing operation of moving to an email message receivable state in the free sample distributing system of the second embodiment.

### BEST MODE FOR CARRYING OUT THE INVENTION

### (A) First Embodiment

A first embodiment of a free sample distributing system, a free sample distribution information server, a free sample distributing device, a free sample distributing method and a free sample distribution information processing program according to the present invention will be described below with reference to the drawings.

### (A-1) Configuration of First Embodiment

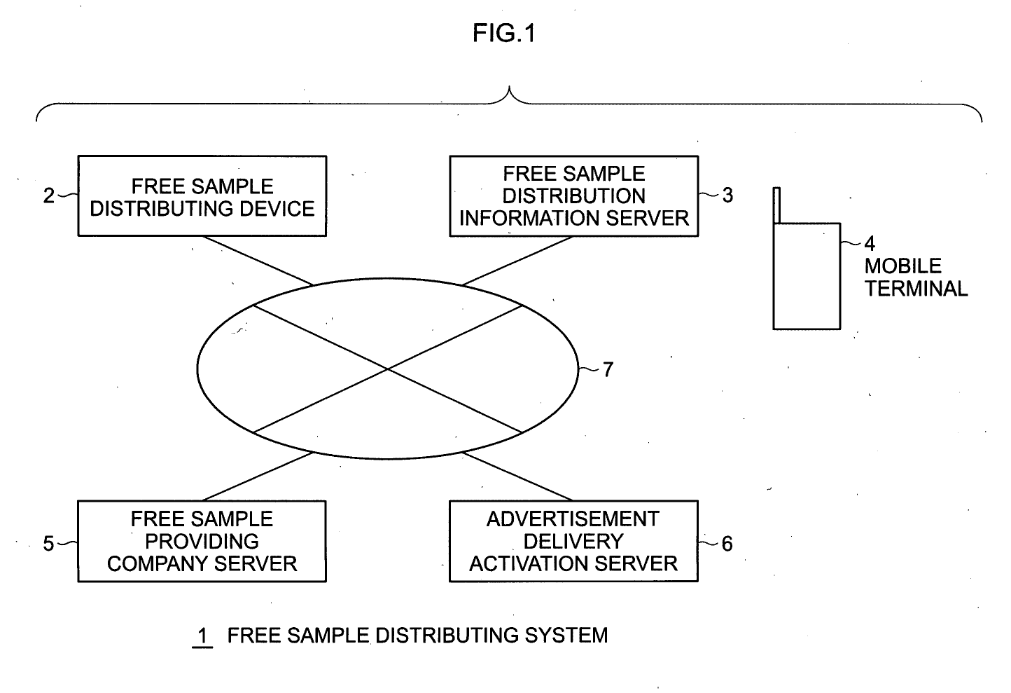

FIG. 1 is a block diagram showing the overall configuration of a free sample distributing system of the first embodiment.

In FIG. 1, a free sample distributing system 1 of the first embodiment has a free sample distributing device 2, a free sample distribution information server 3, a mobile terminal 4, a free sample providing company server 5 and an advertisement delivery activation server 6 and is configured such that the components 2 to 6 can communicate with each other via a network 7. It will be noted that the network 7 may be configured by plural types of networks.

The free sample distributing device 2 is a device that houses, and distributes to users, various types of samples and is installed in a location frequented by the general public, such as, for example, a convenience store or a supermarket.

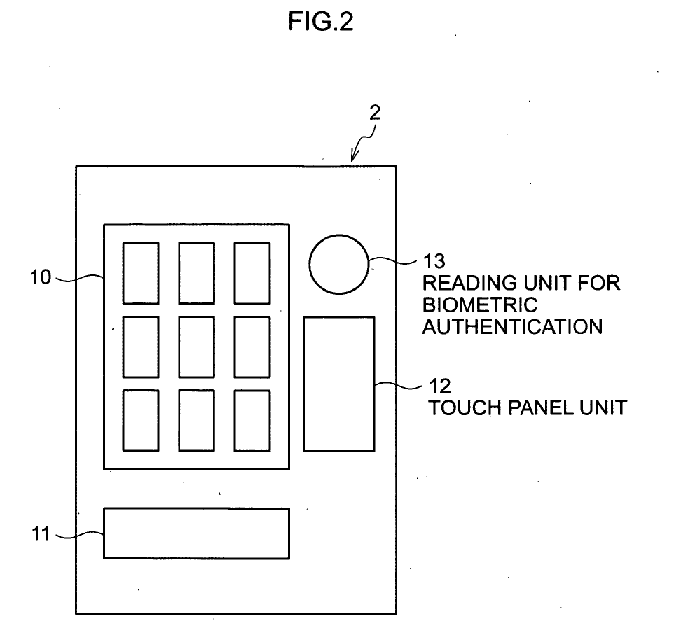

FIG. 2 is a general front view of the free sample distributing device 2. The free sample distributing device 2 is a device where a free sample display unit 10 that displays various types of free samples to a user through glass, for example, a free sample take-out opening 11, a touch panel unit 12 that has a display function and an input function and a reading unit 13 for biometric authentication can be seen from the front. The reading unit 13 for biometric authentication is, for example, a reading unit for iris authentication. Further, inside the free sample take-out opening 11, there is disposed a sensor (e.g., a photoelectric sensor) that monitors whether or not a free sample that has been transferred to the take-out opening 11 has been taken out.

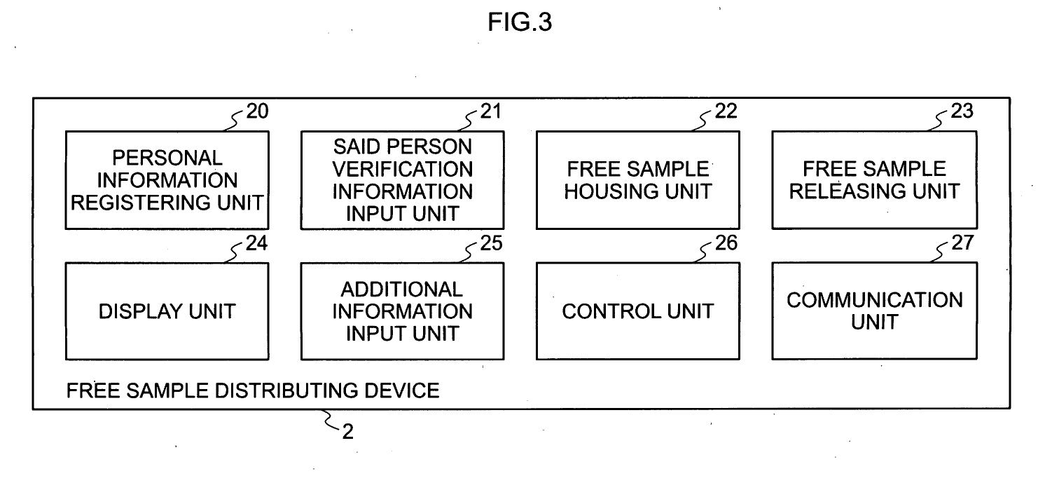

The free sample distributing device 2 has an internal configuration where a CPU centrally performs various types of processing, for example, and functionally has the configuration shown in the block diagram of FIG. 3.

The free sample distributing device 2 has a personal information registering unit 20, a said person verification information input unit 21, plural free sample housing units 22, a free sample releasing unit 23, a display unit 24, an additional information input unit 25, a control unit 26 and a communication unit 27. In the personal information registering unit 20, a user registers personal information. In the said person verification information input unit 21, a user inputs information for verifying that the user is a said registree. The plural free sample housing units 22 respectively house different types of free samples. The free sample releasing unit 23 causes a free sample that has been instructed by the control unit 26 to be discharged from the plural types of free samples. The display unit 24 displays various types of messages (guidance messages, question messages, etc.) to a user. In the additional information input unit 25, a user inputs additional information. The control unit 26 controls the entire free sample distributing device 2. The communication unit 27 executes communication with an external device.

It will be noted that the free sample distributing device 2 may be constructed as a dedicated device or may be constructed such that part of a device such as an automated vending machine doubles as the free sample distributing device 2.

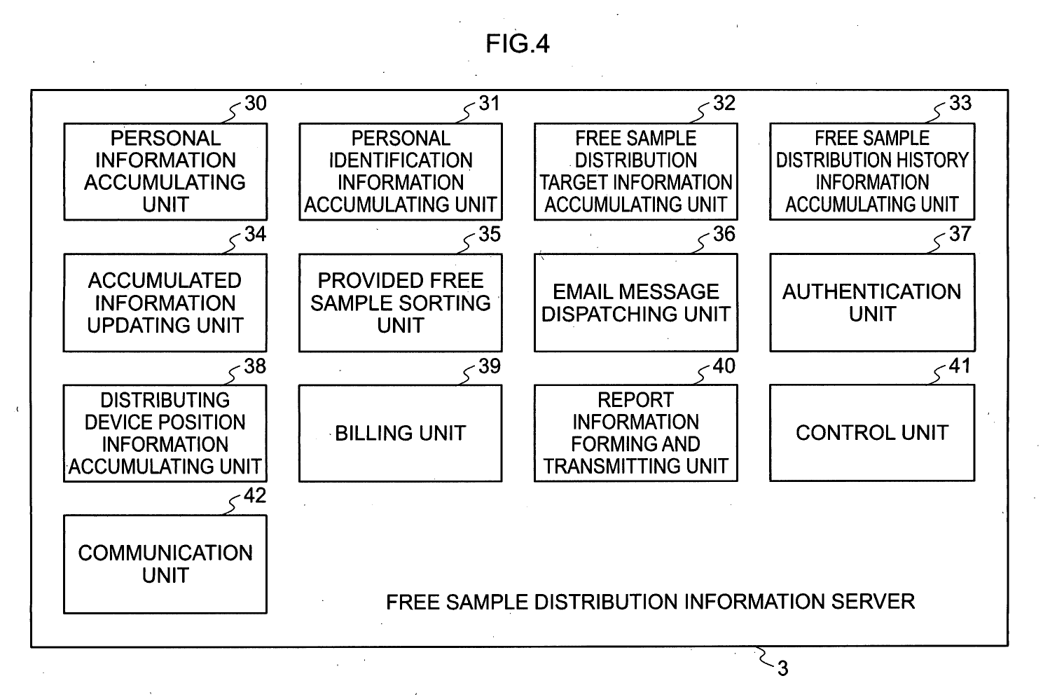

The free sample distribution information server 3 accumulates and manages various types of information related to free sample distribution and executes free sample distribution processing and advertisement delivery processing in accordance with the managed information. The free sample distribution information server 3 comprises, for example, a server (computer) having a large-capacity storage device (the free sample distribution information server 3 may also be constructed by plural servers that perform distributed processing) and functions as the free sample distribution information server 3 as a result of the free sample distribution information processing program of the first embodiment being installed in a server. The free sample distribution information server 3 functionally has the configuration shown in the block diagram of FIG. 4.

The free sample distribution information server 3 has a personal information accumulating unit 30, a personal identification information accumulating unit 31, a free sample distribution target information accumulating unit 32, a free sample distribution history information accumulating unit 33, an accumulated information updating unit 34, a provided free sample sorting (selecting) unit 35, an email message dispatching unit 36, an authentication unit 37, a distributing device position information accumulating unit 38, a billing unit 39, a report information forming and transmitting unit 40, a control unit 41 and a communication unit 42. The personal information accumulating unit 30 accumulates personal information of users by user. The personal identification information accumulating unit 31 accumulates personal identification information of users by user. The free sample distribution target information accumulating unit 32 accumulates, by free sample, classification information of users who become free sample distribution targets (targets) and information relating to the free samples such as distribution periods and whether to ask questions about feedback or the like after use of a free sample (including not just free samples currently being provided but also, for example, free samples for which feedback or the like is to be sought after use a predetermined period of time after provision has ended). The free sample distribution history information accumulating unit 33 records histories such as dates and times when the free samples are distributed to users. The accumulated information updating unit 34 updates the information in the various accumulating units 30 to 33. The provided free sample sorting unit 35 compares (collates, checks) the personal information of users with free sample distribution target information and sorts (selects) the free samples that are to be provided to users. The email message dispatching unit 36 dispatches buffered email messages (e.g., email messages for alerting users of the existence of free samples, email messages simply for advertisement) to users. The authentication unit 37 verifies that a user who has operated the free sample distributing device 2 is a said person whose personal information is registered. The distributing device position information accumulating unit 38 accumulates information relating to the installation position of the free sample distributing device 2. The billing unit 39 performs billing processing to a free sample providing company or an advertising company. The report information forming and transmitting unit 40 forms and transmits report information to the free sample providing company or the advertising company. The control unit 41 controls the entire free sample distribution information server 3. The communication unit 42 executes communication with an external device.

It will be noted that remaining numbers per free sample distributing device 2 are also included in the information relating to the free samples that is accumulated in the free sample distribution target information accumulating unit 32.

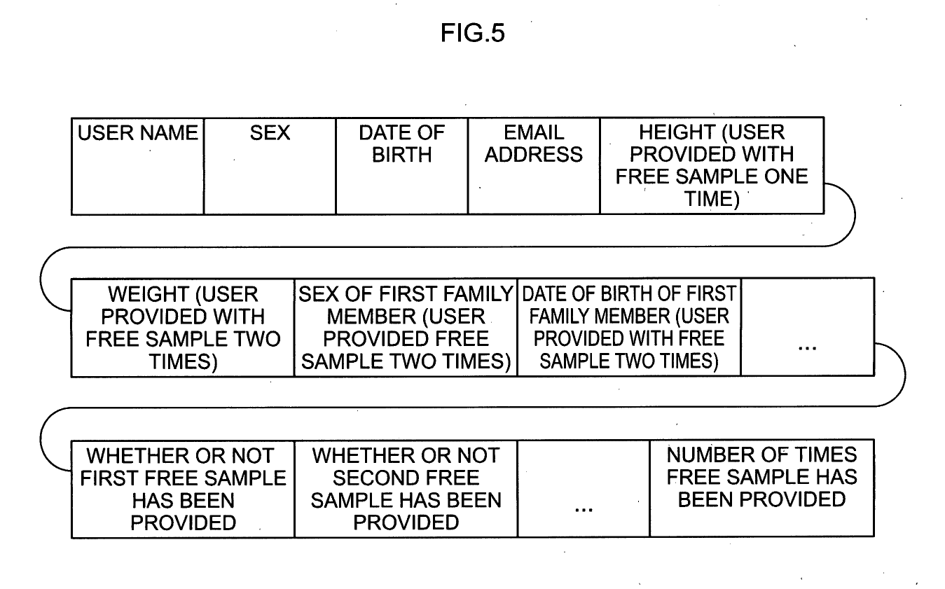

FIG. 5 is an explanatory diagram showing a configural example of the personal information accumulating unit 30. The personal information accumulating unit 30 includes boxes (fields) in which to acquire information at the time of registration, such as the name, sex, date of birth and email address of a user. Further, there are also disposed boxes for information that the free sample distribution information server 3 acquires by asking a user questions after that user is provided with a free sample a predetermined number of times after registration. For example, the height and weight of a user are items for which the free sample distribution information server 3 acquires information by questions that the free sample distribution information server 3 asks when that user has been provided with a free sample one time and immediately before the user is provided with a free sample a second time. Further, for example, the address of a user is an item for which the free sample distribution information server 3 acquires information by a question that the free sample distribution information server 3 asks when that user has been provided with a free sample two times and immediately before the user is provided with a free sample a third time. Moreover, the sex, date of birth and relationship of a first family member of a user are items for which the free sample distribution information server 3 acquires information by questions that the free sample distribution information server 3 asks when that user has been provided with a free sample three times and immediately before the user is provided with a free sample a fourth time. Thereafter, the timing of the questions is prescribed per additional item. This timing of questions per additional item is also written as common personal information in the personal information accumulating unit 30. Further, the number of times a free sample has been provided until now is also disposed as a box (item) per user in the personal information accumulating unit 30. Here, the number of times a free sample has been provided is counted such that, even when plural types of free samples have been provided in a single acquisition operation, this is counted as one time.

The questions or the like that the free sample distribution information server 3 asks of a user are not only questions about additional items pertaining to personal information but can also be questions seeking feedback or the like with respect to free samples that were provided in the past.

Further, as boxes (items) per user in the personal information accumulating unit 30, there are also disposed boxes for whether or not to provide each type of free sample that can be provided at the present time and whether or not an email message has been dispatched in regard to that free sample. The item of whether or not to provide a free sample is replaced with “number of free samples allowed to be provided” and “number of free samples that have been provided” in the case of a free sample such as described later for which provision to a family is permitted.

The mobile terminal 4 is, for example, a mobile telephone and in this case functions as a receiving device that receives the email messages that have been dispatched from the free sample distribution information server 3. The mobile terminal 4 may also, instead of this or in addition to this, be an information processing device such as a portable or stationary personal computer.

In the case of the first embodiment, the email messages that the free sample distribution information server 3 dispatches to the mobile terminal 4 can be email messages notifying the user of the provision of a new free sample or email messages simply for advertisement.

For example, the free sample distributing device 2 and the free sample distribution information server 3 belong to an operating company of the free sample distributing system 1 of the first embodiment. The free sample providing company server 5 belongs to a company or group (hereinafter simply called “company”) that provides free samples, and the advertisement delivery activation server 6 belongs to a company that functions to deliver advertisements.

The free sample providing company server 5 is, for example, configured by a common server. Although illustration of its functional block is omitted, the free sample providing company server 5 requests the free sample distribution information server 3 to dispatch email messages notifying users of the provision of a new free sample and notifies the free sample distribution information server 3 of a target demographic to which the email messages are to be dispatched, the distribution period of the free sample, and whether or not to collect feedback after use. The free sample providing company server 5 specifies the target demographic by the contents of the items accumulated in the personal information accumulating unit 30. For example, free sample providing company server 5 can specify a target demographic like “women in their 20s or 30s (inputted in the range of birthdates) who are 155 cm or taller for those whose height has been inputted”. Further, in addition to registered users or instead of registered users, the free sample providing company server 5 can also set whether to use corresponding families as distribution targets. It will be noted that the free samples are loaded into all or some of the free sample distributing devices 2 before the email messages are dispatched by cooperation between the operating company of the free sample distributing system 1 and the company providing the free samples.

Further, the free sample providing company server 5 can also notify the free sample distribution information server 3 of a target demographic pertaining to the provision of a new free sample, the distribution period and whether or not to collect feedback after use without dispatching the email messages.

The advertisement delivery activation server 6 is, for example, configured by a common server. Although illustration of its functional block is omitted, the advertisement delivery activation server 6 requests the free sample distribution information server 3 to dispatch email messages for advertisement and notifies the free sample distribution information server 3 of a user demographic (target) to which those email messages are to be dispatched. The advertisement delivery activation server 6 also specifies the target demographic in this case by the contents of the items accumulated in the personal information accumulating unit 30. That is, in this first embodiment, the advertisement delivery activation server 6 can utilize the information accumulated in the personal information accumulating unit 30 to dispatch email messages for advertisement to persons (users) of an intended target demographic.

### (A-2) Operation of First Embodiment

Next, various types of operations (the free sample distributing method) of the free sample distributing system 1 of the first embodiment that has the above configuration will be described.

### (A-2-1) User Registration Operation

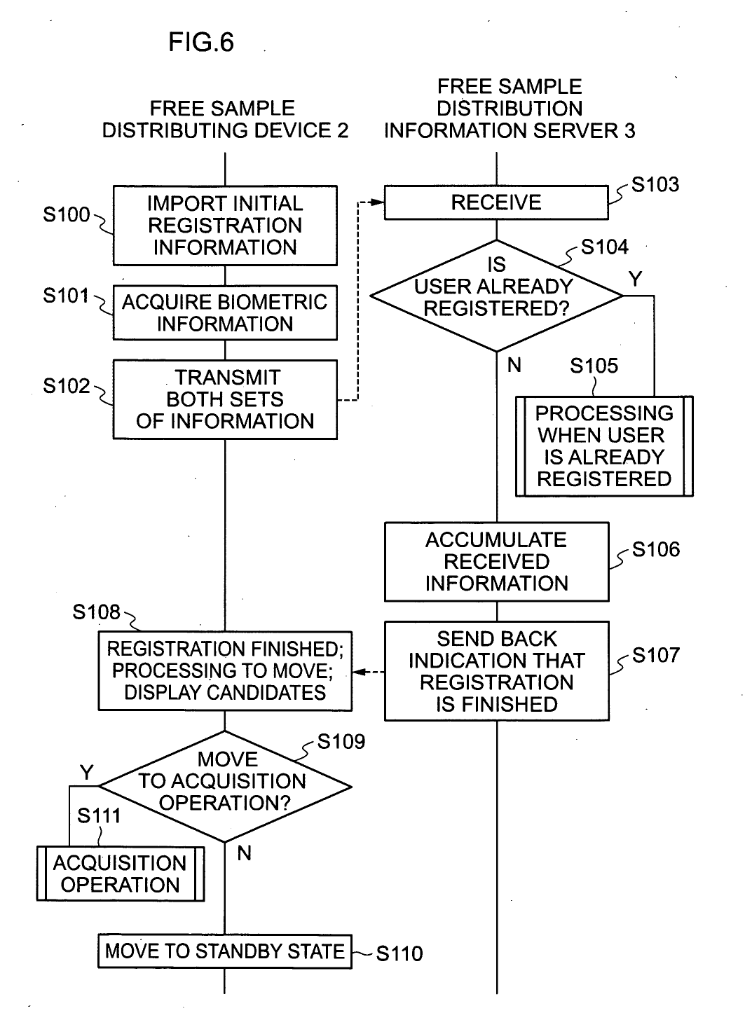

First, operation when a user registers personal information in the free sample distributing system 1 will be described with reference to the sequence diagram of FIG. 6.

On the touch panel unit 12 of the free sample distributing device 2, there are, in a standby state, displayed (icons of) options that allow a user to select operating modes. When an option for registration of personal information is operated, the (personal information registering unit 20 of the) free sample distributing device 2 starts operation for personal information registration.

First, the free sample distributing device 2 displays on the touch panel unit 12 input fields for name, sex, date of birth and email address and a keyboard arrangement and imports the name, sex, date of birth and email address that the user has inputted (S100). When information is inputted and an enter key is operated, the free sample distributing device 2 judges whether or not the information of the four items is in order and whether or not the information of the four items is appropriate as item information (e.g., whether information lacking a month or day has been inputted) and, when the information of the four items that has been inputted is appropriate, imports the information as valid initial registration information.

Thereafter, the free sample distributing device 2 displays on the touch panel unit 12 a message prompting the reading of biometric information and acquires the biometric information (e.g., iris information) with the reading component 13 (S101). It will be noted that the free sample distributing device 2 may, instead of using the read image as is as the biometric information, extract and use as the biometric information a characteristic amount or the like from the read image; this extraction processing may be performed by the free sample distributing device 2 or may be performed by the free sample distribution information server 3.

When the free sample distributing device 2 acquires the initial registration information and the biometric information, the free sample distributing device 2 transmits both sets of information to the free sample distribution information server 3 (S102). When the free sample distribution information server 3 receives the initial registration information and the biometric information, the free sample distribution information server 3 discriminates whether or not information of the user seeking registration is already registered (S103, S104). For example, when information where the sex and the date of birth in the initial registration information are the same and where the biometric information is also the same (where the degree of similarity is equal to or greater than a predetermined threshold) is already registered, the free sample distribution information server 3 discriminates that the information of the user seeking registration is already registered. That is, the free sample distribution information server 3 judges that the information of that user is already registered when the information satisfies the above-described condition even if at least one of the name and the email address is different.

When the information of the user seeking registration is already registered, the free sample distribution information server 3 performs processing for that case (S105). For example, the free sample distribution information server 3 may be configured to overwrite the already registered information. Further, for example, the free sample distribution information server 3 may be configured to notify the user wanting to be registered that the user is already registered and have the user designate whether or not the free sample distribution information server 3 should overwrite the already registered information (or give priority to the already registered information). Moreover, for example, the free sample distribution information server 3 may be configured to ignore the information that has been inputted this time. It will be noted that an aspect where the free sample distribution information server 3 executes overwriting becomes the same aspect as when the free sample distribution information server 3 has performed editing.

When the information of the user seeking registration is not registered, the free sample distribution information server 3 accumulates the new registration information in the personal information accumulating unit 30 and accumulates the biometric information (personal identification information) of the user in the personal identification information accumulating unit 31 so as to establish a correspondence between both (S106). Then, the free sample distribution information server 3 sends an indication that the new registration has been finished back to the free sample distributing device 2 (S107).

The free sample distributing device 2 to which the indication that the new registration has been finished has been sent back displays on the touch panel unit 12 an indication that the personal information has been registered and also causes the touch panel unit 12 to display contents asking whether the user wants to end the procedure at this stage or move immediately to free sample acquisition operation (S108). Then, the free sample distributing device 2 waits for operation from the user and discriminates whether to end the procedure or move immediately to free sample acquisition operation (S109).

When the free sample distributing device 2 is instructed by the user to end the procedure, the free sample distributing device 2 returns the display of the touch panel unit 12 to the display in the standby state (S110) and ends the series of registration processing steps. On the other hand, when the free sample distributing device 2 is instructed by the user to move to free sample acquisition operation, the free sample distributing device 2 moves to later-described free sample acquisition operation (S111).

In the above description, a case has been described where the user is made to input the initial registration information from the touch panel unit 12 of the free sample distributing device 2, but another input method may of course also be applied. For example, an OCR may be disposed in the free sample distributing device 2, sheets of paper for form input may be disposed near the free sample distributing device 2, and the free sample distributing device 2 may import the initial registration information by using the OCR to recognize the sheet of paper on which the user has written. Further, for example, the user may access a designated URL from the mobile terminal 4, retrieve a webpage for input and register the initial registration information. In this case, an image shot with a camera of the mobile terminal 4 may be utilized as the biometric information, or the free sample distributing device 2 may be made to read the biometric information.

The biometric information which is utilized for personal identification is not limited to iris information as described above and may also be other biometric information, such as a fingerprint, a voiceprint or a face. Further, in addition to the biometric information or instead of the biometric information, a physical identification medium such as a card or may utilize a password or the like may be applied. A unique physical identification medium such as a card may be one that the free sample distributing device 2 discharges.

In the above description, a case has been described where the initial registration information is the name, sex, date of birth and email address of the user, but the initial registration information may also include other information.

In the above description, initial registration operation has been described, but the free sample distributing system 1 may also be configured such that information that has been initially registered can also be edited, such as being changed or deleted. Here, the free sample distributing system 1 is configured such that, when the user makes such changes, the user cannot change his/her sex and date of birth even if the free sample distributing system 1 permits changes to his/her name and email address. It will be noted that the free sample distribution information server 3 may also be configured to automatically delete the registration information of a user who has not been provided with a free sample over a long period of time (e.g., one year) or may also be configured to notify that user by email before automatically deleting the registration information of that user.

### (A-2-2) Free Sample Provision Email Message Dispatching Operation

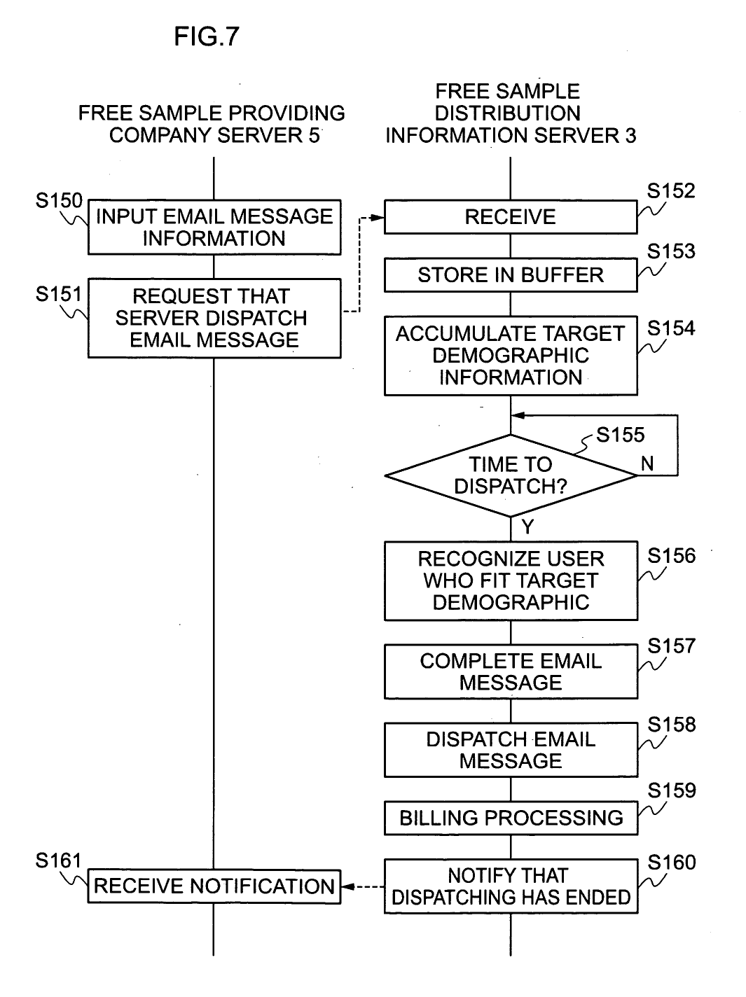

Next, operation when dispatching to intended users an email message notifying those users of the provision of a new free sample will be described with reference to the sequence diagram of FIG. 7.

Preliminarily, the free sample providing company or the operating company of the free sample distributing system 1 contacts the person-in-charge or the like of the store where the free sample distributing device 2 is installed to have that person replace a free sample inside one of the free sample housing units 22 in a predetermined position in the free sample distributing device 2 with a new free sample that the free sample providing company wants to provide by a predetermined date and time. Further, the free sample providing company or the operating company of the free sample distributing system 1 disposes a box relating to the new free sample that the free sample providing company wants to provide in the personal information accumulating unit 30 and the free sample distribution target information accumulating unit 32 of the free sample distribution information server 3.

The operator of the free sample providing company inputs, with respect to the free sample providing company server 5 at a timing before the start of provision of the new free sample, for example, the body of the email message including contents marketing the new free sample that the free sample providing company will provide, information about the target demographic to which the free sample is to be provided, and the date and time when the email message should start to be dispatched (S150). The free sample providing company server 5 transmits, to the free sample distribution information server 3, a request to dispatch the email message that includes those sets of input information (S151). The operator may limit designation of the target demographic only to registered users themselves or may designate the target demographic so as to permit cases where only families apply.

The free sample distribution information server 3 receives the request to dispatch the email message (S152), stores the body of the email message it has received in a body storage region in an email buffer, inserts the email address pertaining to that free sample distribution information server 3 in a field of the source of transmission of the email message (S153), stores the information about the target demographic of the free sample included in the dispatch request in the free sample distribution target information accumulating unit 32 (S154), and waits until the date and time when the free sample distribution information server 3 should start dispatching the email message (S155). Here, there is described an example of a case where the target demographic to which the email message is to be sent and the target demographic to which the free sample is to be provided coincide with each other, but the target demographic to which the email message is to be sent and the target demographic to which the free sample is to be provided do not invariably have to coincide with each other.

When the date and time when the free sample distribution information server 3 should start dispatching the email message arrives, the free sample distribution information server 3 references the personal information accumulated in the personal information accumulating unit 30 to search for users or families (in the case of families, only when it is set such that the target demographic may be a family) whose personal information fits the information of the target demographic included in the request to dispatch the email message (S156), completes the email message by inserting the email addresses described in the personal information accumulating unit 30 in a destination address field (S157), dispatches that email message, and writes an indication that it has finished dispatching the email message in regard to the pertinent free sample for the pertinent users in the personal information accumulating unit 30 (S158). Here, the free sample distribution information server 3 may be configured to move to dispatching of the email message after waiting on the search for all pertinent users or may be configured to dispatch the email message each time one pertinent user is searched for (FIG. 7 describes the former case).

Thereafter, the free sample distribution information server 3 performs billing processing of the dispatch service charge corresponding to the number of email messages it dispatched (S159) and transmits to the free sample providing company server 5 a notification that it has finished dispatching the email message including the number of email messages it dispatched (S160). It will be noted that the free sample distribution information server 3 ensures that no personal information by which a particular individual can be recognized is included in the notification that it has finished dispatching the email message.

Above, there has been described a case where an upper limit on the number of email messages to dispatch is not included in the request to dispatch the email message, but an upper limit on the number of email messages to dispatch may be included in the request to dispatch the email message.

In this case, the free sample distribution information server 3 discriminates whether or not the number of users corresponding to the target demographic that has been obtained as a result of searching the personal information accumulating unit 30 exceeds the upper limit on the number of email messages that the free sample distribution information server 3 is to dispatch. When the number of users exceeds the upper limit, the free sample distribution information server 3 decides on users to whom it will not dispatch the email message from users for whom the number of times a free sample has been provided is small, for example. In a situation where some from users of the same condition must be determined, a random number, for example may be utilized.

The free sample distribution information server 3 may also, only in a case where the number of users corresponding to the target demographic that has been obtained as a result of searching the personal information accumulating unit 30 does not reach the upper limit on the number of email messages that the free sample distribution information server 3 is to dispatch, be configured to search whether there are persons corresponding to the target demographic within families and decide on users who have family members corresponding to the target demographic as persons to whom to dispatch the email message.

Further, above, there has been described operation where an email message notifying users of the provision of a new free sample is dispatched, but the email message may also notify users of advice or the like on how to use the free sample.

In the case of this first embodiment, an email message simply for advertisement may be also dispatched, and operation where an email message for advertisement is dispatched is substantially the same as the aforementioned operation where the email message notifying users of the provision of a new free sample is dispatched.

The sequence diagram is omitted, but when the operator inputs, with respect to the advertisement delivery activation server 6, the body of the email message including advertisement contents, information about the target demographic to which the advertisement is to be distributed, and the date and time when the email message should start to be dispatched, the advertisement delivery activation server 6 transmits to the free sample distribution information server 3 a request to dispatch the email message including those sets of input information. When the free sample distribution information server 3 receives this dispatch request, the free sample distribution information server 3 determines the users to whom the email message is to be sent, dispatches the email message, and appropriately performs billing and reporting in the same manner as in the aforementioned case. In this case, the free sample distribution information server 3 may be configured to record an indication that it has dispatched the email message for advertisement in the personal information accumulating unit 30 or, conversely, may be configured to not record anywhere an indication that it has dispatched the email message for advertisement.

The email message for advertisement may, for example, be created by analyzing the feedback of numerous users with respect to a free sample with which they have been provided and deciding on a product to be advertised.

In the above description, there has been described a case where the request to dispatch the email message notifying users of the provision of a new free sample is performed by communication from the free sample providing company server 5 to the free sample distribution information server 3, but the request to dispatch the email message may also be made to the free sample distribution information server 3 using a keyboard or the like. The same is also true in regard to the email message for advertisement.

### (A-2-3) Free Sample Provision Operation

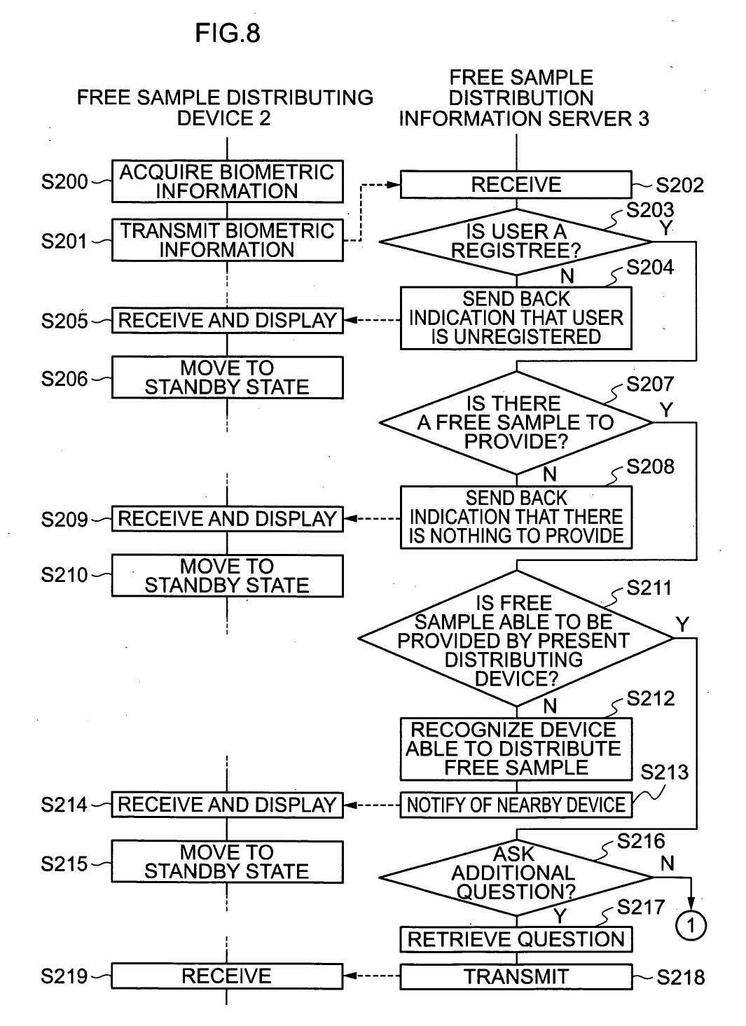

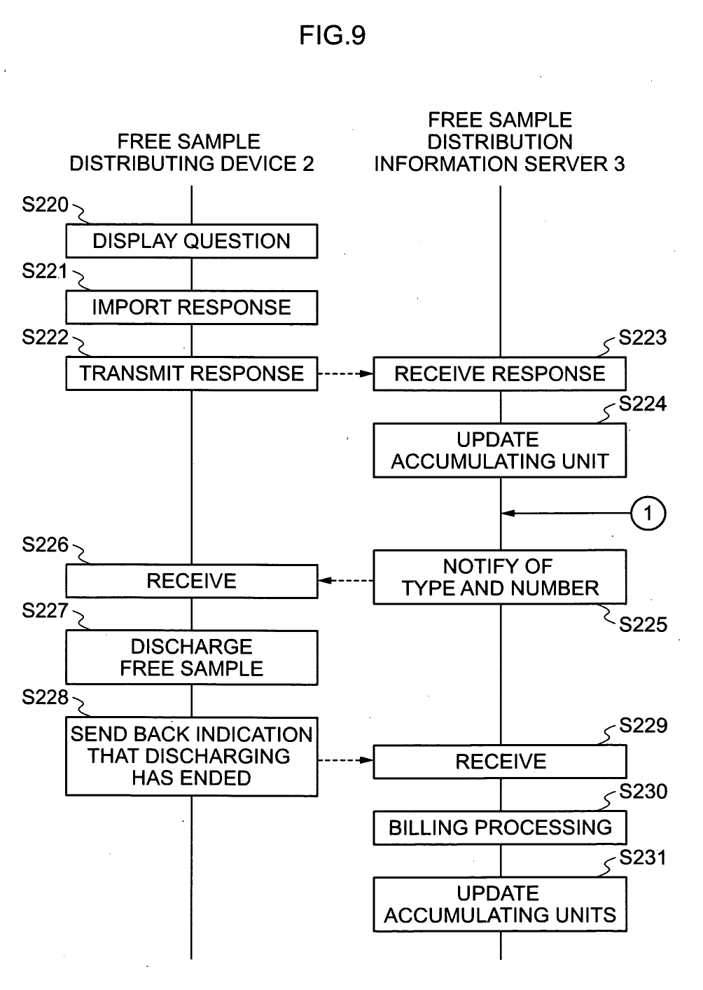

Next, operation when providing a free sample to a user will be described with reference to the sequence diagrams of FIG. 8 and FIG. 9.

The free sample providing company can ask the operating company of the free sample distributing system 1 to house in the free sample distributing device 2 a new free sample that it will provide without dispatching an email message. The free sample providing company notifies the operating company of the free sample distributing system 1 of information about the target demographic to which the free sample is to be provided, the period in which the free sample is to be provided, and whether or not to seek feedback with respect to the free sample provision (accompanied by a deadline to verify feedback), regardless of whether or not an email message is to be dispatched. A notification of this information may be carried out by communication from the free sample providing company server 5 to the free sample distribution information server 3 or may be carried out by telephone or the like and input the information to the free sample distribution information server 3 using a keyboard or the like.

It will be noted that the target demographic to which the email message is to be sent and the target demographic for which provision of the free sample is to be allowed do not invariably have to coincide with each other. For example, even if the target demographic to which the email message is to be sent is “women in their 20s”, the target demographic for which provision of the free sample is to be allowed may be set to “women from age 18 to age 32”.

For example, users who receive the email message including contents marketing the new free sample to be provided and who have an interest in that free sample perform free sample acquisition operation with respect to any of the free sample distributing devices 2 after provision of the free sample starts. Further, for example, users who pass by the free sample distributing device 2 and have an interest in any of the free samples displayed in the free sample display unit 10 perform free sample acquisition operation with respect to the free sample distributing device 2.

As mentioned above, on the touch panel unit 12 of the free sample distributing device 2, there are, in the standby state, displayed (icons of) options that allow a user to select operating modes, and when an option for free sample provision (or free sample acquisition from the standpoint of the user) is operated, the free sample distributing device 2 starts free sample provision operation.

Then, first, the free sample distributing device 2 displays on the touch panel unit 12 a message prompting the reading of biometric information and acquires the biometric information (e.g., iris information) with the reading unit 13 (S200). It will be noted that the free sample distributing device 2 may also be configured to have the user input personal information such as his/her name in addition to the biometric information in order to facilitate searching by the free sample distribution information server 3. It will be noted that, if the system is one that performs personal identification (authentication) with biometric information and a password, the user must input a password in addition to the biometric information.

When the free sample distributing device 2 acquires the biometric information (personal identification information), the free sample distributing device 2 transmits the biometric information to the free sample distribution information server 3 (S201). When the free sample distribution information server 3 receives the biometric information (S202), the free sample distribution information server 3 verifies whether the user who performed free sample acquisition operation is a registered person by identifying the biometric information with the accumulated information in the personal identification information accumulating unit 31 (S203).

If the user who performed free sample acquisition operation is not a registered person, the free sample distribution information server 3 sends an indication thereof back to the free sample distributing device 2 (S204), and when the free sample distributing device 2 receives that notification, the free sample distributing device 2 displays, for a certain amount of time, an indication that it is unable to provide a free sample because the user is an unregistered person and thereafter returns the display to the standby state (S205, S206). It will be noted that the free sample distributing device 2 may also be configured to display, together with the indication that it is unable to provide a free sample because the user is an unregistered person, an icon or the like for allowing the user to move to registration operation.

If the user who performed free sample acquisition operation is a registered person, the free sample distribution information server 3 references the personal information of that registered user in the personal information accumulating unit 30 and discriminates whether or not there is a type of free sample that should be provided (S207). A free sample that should be provided is a type of free sample to whose target demographic the registered user or a family member thereof corresponds (in regard to a family member, this is limited to a case where there is description indicating that the target demographic may also be a family member) and which the free sample distributing device 2 has not yet provided to the registered user. For example, the free sample distributing device 2 verifies whether the registered user or a family member corresponds to the target demographic per free sample, and when the registered user or the family member corresponds to the target demographic, the free sample distributing device 2 discriminates whether or not there is a free sample to be provided by further verifying whether or not the free sample has been provided.

When even one type of free sample does not correspond to a free sample that should be provided, the free sample distribution information server 3 sends an indication thereof back to the free sample distributing device 2 (S208). When the free sample distributing device 2 receives that notification, the free sample distributing device 2 displays, for a certain amount of time, an indication that there are no free samples to be provided at the present time and thereafter returns the display to the display in the standby state (S209, S210).

When at least one type of more applies as a free sample that should be provided, the free sample distribution information server 3 discriminates whether or not the free sample that should be provided is housed in the free sample distributing device 2 where free sample acquisition operation has been performed (S211). The free sample distribution information server 3 performs this discrimination in accordance with the accumulated information in the free sample distribution target information accumulating unit 32 (the remaining number per free sample distributing device 2). It will be noted that, instead of the aforementioned discrimination method, the free sample distribution information server 3 may also be configured to perform discrimination after performing communication to verify the number of free samples housed in the free sample distributing device 2.

When no free samples that should be provided are housed in the free sample distributing device 2 where free sample acquisition operation has been performed, the free sample distribution information server 3 determines a nearby free sample distributing device 2 that is capable of providing a free sample that should be provided per each type of free sample on the basis of the accumulated information in the distributing device position information accumulating unit 38 and the accumulated information in the free sample distribution target information accumulating unit 32 (S212) and sends back information about the nearby device that is capable of providing a free sample that should be provided and an indication that no free samples to be provided are housed in the operated device (S213). When the free sample distributing device 2 receives that notification, the free sample distributing device 2 displays the received contents for a predetermined amount of time and thereafter returns the display to the display in the standby state (S214, S215).

When at least one type of free sample that should be provided is housed in the free sample distributing device 2 where free sample acquisition operation has been performed, the free sample distribution information server 3 discriminates whether or not the user is a user to whom a question about an additional item pertaining to personal information should be asked on the basis of the number of times a free sample has been provided to the registered user until just before the registered user performed free sample acquisition operation and, if a free sample was provided in the past to that user, whether or not the starting point to ask for feedback or the like in regard to that free sample has passed (S216). For example, if the free sample distribution information server 3 asks a question about an additional item with respect to a user where the number of times a free sample has been provided to that user until just before is 0 times to 5 times, the free sample distribution information server 3 discriminates whether or not the user is a user to whom to ask a question about an additional item depending on whether the number of times a free sample has been provided to that user until just before is 5 times or less or 6 times or more. Further, for example, if the user has, one month or more prior, been provided with a free sample for which feedback (e.g., whether use was “good”, “OK”, “bad”, etc.) is to be sought after one month passes after being provided with the free sample, the free sample distribution information server 3 discriminates whether or not it has already obtained feedback about that free sample.

If the user is a user to whom a question about an additional item is to be asked or is a user from whom feedback after use is to be sought, the free sample distribution information server 3 retrieves a question about an additional item determined by the number of times a free sample has been provided to that user until just before or retrieves a designated question asking for feedback and transmits the question to the free sample distributing device 2 (S217, S218). When the free sample distributing device 2 receives the question, the free sample distributing device 2 displays the question on the touch panel unit 12, imports the response from the user, and sends the response back to the free sample distribution information server 3 (S219 to S222).

It will be noted that an option such as “I don't want to respond” with respect to a question about an additional item pertaining to personal information may be allowed or required items and optional items may be disposed and displayed such that they are distinguishable. Further, when both a question about an additional item and a question asking for feedback are asked, the other question may present after the user responds to one question. As for questions asking for feedback, when several of the same free sample (for the registered person and for a family member) are provided, it is preferable to have the user respond a number of times equal to the number of the free sample that was provided.

When the free sample distribution information server 3 receives a response with respect to the question (including “I don't want to respond”), the free sample distribution information server 3 performs processing and the like to update the accumulating unit corresponding to that response (S223, S224). For example, if the response is a response with respect to a question about an additional item pertaining to personal information, the free sample distribution information server 3 adds information to the pertinent blank item in the personal information accumulating unit 30 in accordance therewith. Further, for example, when a response to a question asking for feedback has been obtained, the free distribution information server 3 updates the number of responses with respect to that free sample and the number of times options such as “good”, “OK” and “bad” have been selected, which the report information forming and transmitting unit 40 internally manages. It will be noted that the timing when the report information forming and transmitting unit 40 forms and transmits to the free sample providing company server 5 report information in regard to feedback is, for example, a timing that has been instructed from the free sample providing company server 5 (e.g., at midnight on the Monday of each week).

When the free sample distribution information server 3 ends update processing corresponding to a response or the like or when the user is a user that does not need to be asked a question, the free sample distribution information server 3 notifies the free sample distributing device 2 of the type information (including information as to whether or not it has dispatched an email message telling the user of the existence of the new free sample) and the number of the free sample that should be provided which is housed in the free sample distributing device 2 where free sample acquisition operation has been performed (S225). It will be noted that, when there is a type of free sample that is provided but is unable to provide because that free sample is not housed in the free sample distributing device 2, indication thereof may be included in the notification. Further, when there is a type of free sample for which feedback is to be sought at a later date among the types of free samples that is provided, indication thereof may be also included in the notification information.

The free sample distributing device 2 receives the above-described information (S226), displays a list of free samples to be provided (types, numbers, request for feedback at a later date, etc.), and sequentially discharges (presents) the corresponding free sample (S227). For example, after the free sample distributing device 2 discharges one free sample, the free sample distributing device 2 verifies with the sensor that the free sample has been taken out from the take-out opening 11 and discharges the next free sample.

Here, when both a free sample about which an email message telling a registered user about the existence of a new free sample has been dispatched to that registered user and a free sample about which such an email message has not been dispatched to the registered user are provided, the latter is discharged first. This is because the potential is high for the registered user to be performing acquisition operation because the user wants to acquire the free sample about which the email message has been dispatched, and if the free sample about which an email message has been dispatched is discharged first, the potential is high for the registered user to not walk away with another free sample. Among the free samples about which an email is not dispatched, there are free samples that it is desired for a target demographic to try but with respect to which is unable to supply a trigger for acquisition with an email message.

When the provision of all free samples that should be provided ends, the free sample distributing device 2 sends a notification that it has finished providing the free sample back to the free sample distribution information server 3 (S228). When the free sample distribution information server 3 receives the notification that the free sample distributing device 2 has finished providing the free sample, the free sample distribution information server 3 performs billing processing corresponding to the type and the number of the provided free sample and performs update processing to update the accumulating units (S229 to S231).

The update processing that the free sample distribution information server 3 performs after the free sample distributing device 2 has provided the free sample includes incrementing the number of times the free sample has been provided by 1 in the personal information accumulating unit 30, writing that the free sample has been provided and the number of the free sample that was provided in the boxes of the corresponding free sample in the personal information accumulating unit 30, updating the remaining number of the corresponding free sample in the free sample distributing device 2 that performed provision operation in the free sample distribution target information accumulating unit 32, and adding this time's history information to the free sample distribution history information accumulating unit 33. Further, at this time, the free sample distribution information server 3 may also be configured to update (form) report information pertaining to the distribution of that free sample which the report information forming and transmitting unit 40 internally manages. The timing of the transmission of this report information is arbitrary.

### (A-3) Effects of First Embodiment

According to the first embodiment, it becomes possible to more reliably provide free samples to users intended by the distribution side.

If the user fits a target demographic and a free sample has not been yet provided to that user, a free sample is provided. For that reason, from the standpoint of a certain free sample providing company, a free sample can also be delivered to users who do not under present circumstances have an interest in that company's products, and the opportunity to motivate users to make a new purchase is obtained. In this connection, in the case of street distribution, users do not accept free samples in which they have no interest.

It is configured to gradually acquire personal information of users per provision. For that reason, there is less of a burden in comparison to when users input personal information all at one time, and acquiring personal information in regard to many items can be expected. As a result, designation of a target demographic becomes appropriate, and free samples can be provided more reliably to users intended by the distribution side.

It is configured to use a registration system for users to whom it provides free samples and to manage whether or not it has provided free samples to those users. For that reason, the same user can be prevented from taking the same free sample two times or three times. In this connection, in the case of street distribution, the same user cannot practically be prevented from taking the same free sample two times or three times.

Families (which may also be other surrounding people (friends)) are also managed as personal information of registered users and families are also be designated as targets. For this reason, a user's worth or a family's worth of free samples can be provided and free samples for families can be provided.

It is configured to notify free sample distribution targets by email when provision of a free sample will start, so free samples can be provided more reliably to users intended by the distribution side. On the other hand, from the standpoint of the user, free sample information is sent by email, so the user can easily understand when and what kinds of free samples can be received at the free sample distributing devices. Further, installation of the free sample distributing devices exhibits a useful customer-attracting effect, and stores and the like that install the free sample distributing devices can expect an even greater customer-attracting effect by dispatching an email message notifying users when provision of a free sample will start.

It is configured such that it can designate target demographics with respect to registered users who want free samples to be distributed to them and can dispatch email messages for advertisement. For that reason, useful advertisements can be delivered to users and the like to whom free samples have been distributed.

Further, it is configured to not include information about the preferences of users in the personal information. For that reason, in this sense also, there become fewer instances where the preferences (desires) of users and provided free samples coincide with each other, and from the standpoint of the free sample providing company, free samples can also be delivered to users who do not under present circumstances have an interest in that company's products.

### (B) Second Embodiment

Next, a second embodiment of the free sample distributing system, the free sample distribution information server, the free sample distributing method and the free sample distribution information processing program according to the present invention will be described with reference to the drawings.

The free sample distributing system of the second embodiment is one that is configured to handle users who do not receive email messages from the free sample distribution information server 3 and users who do not respond to questions about additional items of personal information or questions about feedback after use of free samples.

Differences from the first embodiment will be described below. First, the configuration and operation that handles users who do not receive email messages will be described.

In the case of the second embodiment, as a box (item) per user in the personal information accumulating unit 30, there is also disposed a just-before number of consecutive error email messages (the number of times that reception of dispatched email messages has been blocked or the number of times that dispatched email messages have been returned because an email address does not exist).

This just-before number of consecutive error email messages is cleared to 0 by the (control unit 41 of the) free sample distribution information server 3 when, in a case where the free sample distribution information server 3 has dispatched an email message notifying a user of the provision of a new free sample or has dispatched an email message for advertisement, an error email message has not been sent back to the free sample distribution information server 3 by the elapse of an amount of error email message monitoring time (e.g., 2 minutes) (e.g., monitored by a software timer) after the dispatch of that email message. Further, the just-before number of consecutive error email messages is incremented by 1 by the (control unit 41 of the) free sample distribution information server 3 when an error email message has been sent back within the amount of error email message monitoring time after the dispatch of that email message.

The just-before number of consecutive error email messages is used to judge whether or not to seek return to a state where an email message arrives in operation when providing a free sample to a user.

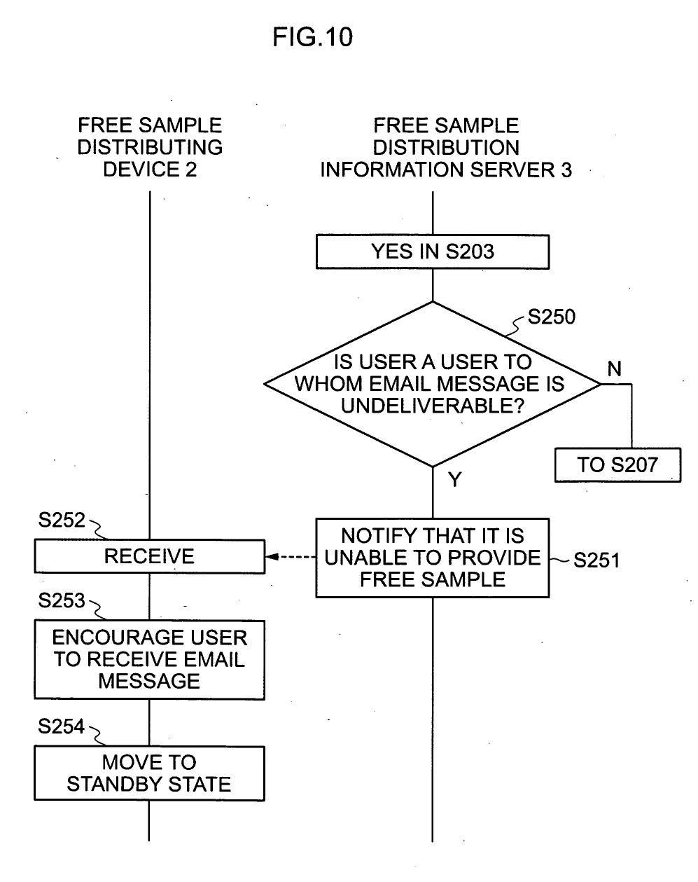

FIG. 10 shows a portion of a sequence that is added to the flow of processing of FIG. 8 and FIG. 9 pertaining to the first embodiment. FIG. 10 is a processing portion when a YES result is obtained in the discrimination of whether or not the user who performed free sample acquisition operation is registered (see S203).

If the user who performed free sample acquisition operation is a registered person, the free sample distribution information server 3 compares the just-before number of consecutive error email messages of that registered user in the personal information accumulating unit 30 with a threshold number-of-times and discriminates whether or not the user is a user who needs to be encouraged to move to an email message receivable state (S250). For example, for a user where the just-before number of consecutive error email messages is 3 times or more, the free sample distribution information server 3 decides to encourage the user to move to an email message receivable state, and for a user where the just-before number of consecutive error email messages is 2 times or less, the free sample distribution information server 3 decides that the user is a user on whom it will impose no restrictions.

If the user is not a user who needs to be encouraged to move to an email message receivable state, the free sample distribution information server 3 references the personal information of that registered user in the personal information accumulating unit 30 and discriminates whether or not there is a type of free sample that should be provided (S207). Thereafter, the similar processing is performed as in the first embodiment.

In contrast, if the user is a user who needs to be encouraged to move to an email message receivable state, the free sample distribution information server 3 transmits to the free sample distributing device 2 an indication that the free sample distribution information server 3 is unable to provide free samples to that user because error email messages continue (S251). When the free sample distributing device 2 receives that notification (S252), the free sample distributing device 2 displays, for a predetermined amount of time, an indication that it is unable to provide free samples to that user unless the user moves to an email message receivable state (S253), and thereafter the free sample distributing device 2 returns the display to the display in the standby state (S254).

A user who strongly wants to acquire a free sample will move to a state where that user can receive the email messages that the free sample distribution information server 3 has dispatched. There are, for example, two types of methods for this.

The first method is a method where the user changes his/her email address to a new email address by editing his/her personal information. In this case, the free sample distribution information server 3 clears to 0 the just-before number of consecutive error email messages box (item) of the corresponding user.

The second method is a case where the user unblocks the email messages that are dispatched from the free sample distribution information server 3. For example, the user may remove the email address of the free sample distribution information server 3 from a list of blocked email addresses in the mobile terminal 4 or may remove the email address of the free sample distribution information server 3 from a list of blocked email addresses in the service server of the carrier pertaining to the mobile terminal 4. With just this operation, the free sample distribution information server 3 cannot recognize that the user side (the mobile terminal 4) has moved to an email message receivable state, so the free sample distribution information server 3 performs operation so that it can recognize this.

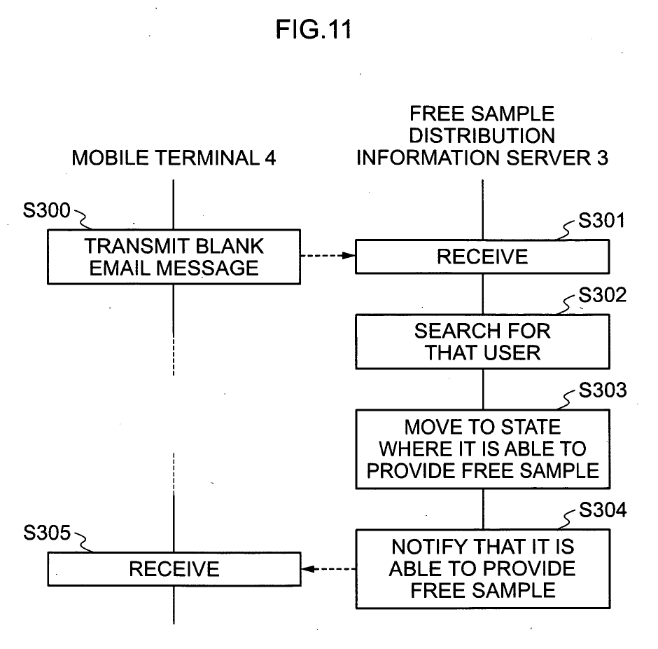

FIG. 11 is a sequence diagram showing operation of the free sample distribution information server 3 and the mobile terminal 4 at this time.

In the display of the indication resulting from aforementioned step S253 that it is unable to provide free samples to the user unless that user moves to an email message receivable state, there are included contents asking that “Users who have unblocked our email messages should transmit a blank email message to this predetermined email address” (an email address that is used in order to recognize the lift (unblocking) in the free sample distribution information server 3).

For that reason, the user transmits a blank email message from the mobile terminal 4 (S300). The free sample distribution information server 3 receives this blank email message (S301) and references the personal information accumulating unit 30 to search for the user whose email address is the email address from which the blank email message was transmitted (S302). Then, the free sample distribution information server 3 clears to 0 the just-before number of consecutive error email messages box (item) of the corresponding user (S303) and dispatches to that user (the mobile terminal 4) an email message indicating that the free sample distribution information server 3 has returned to a state where it is able to provide free samples.

Next, the configuration and operation that handle a user who does not respond to questions about additional items of personal information or questions about feedback after use of free samples will be described.

As described in the first embodiment, there are, as boxes (items) per user in the personal information accumulating unit 30, boxes for questions about additional items pertaining to personal information and boxes for questions seeking feedback or the like with respect to a free sample provided in the past, and response contents are described in these boxes when there is a response. In the first embodiment, these boxes are left blank when there is no response even after asking a question, and there are no restrictions resulting from a user not responding.

In this second embodiment, when the free sample distribution information server 3 obtains a response with respect to a question and that response is “I don't want to respond”, the free sample distribution information server 3 increments by 1 the number of non-responses in the boxes for questions about additional items and the boxes for questions seeking feedback or the like (see aforementioned S223, S224).

Further, in the case of the second embodiment, in contrast to the first embodiment, questions about additional items pertaining to personal information that are transmitted from the free sample distribution information server 3 to the free sample distributing device 2 (see aforementioned S217) are such that their place in a predetermined order in which to ask the questions is the smallest among questions for which a response has not been obtained. For example, when a response has been obtained with respect to a question about an additional item for the second time but has not obtained a response with respect to a question about an additional item for the third time, the next question about an additional item becomes a question about an additional item for the third time. Further, questions seeking feedback or the like are questions where the starting day when it is alright to ask questions is the earliest.

When the number of non-responses to a question determined in these deciding methods is equal to or greater than a predetermined number of times (e.g., equal to or greater than 2 times), although a sequence diagram is omitted, the free sample distribution information server 3 transmits to the free sample distributing device 2 that question and an indication that the free sample distribution information server 3 is unable to provide free samples because the user continues to not respond. When the free sample distributing device 2 receives that notification, the free sample distributing device 2 displays the question and an indication that it is unable to provide free samples because the user continues to not respond, and the free sample distributing device 2 waits for a response. When a response is given, the free sample distributing device 2 transmits the response contents to the free sample distribution information server 3. The free sample distribution information server 3 executes processing from step S223 on which was described in the first embodiment.

According to the second embodiment, when a situation where email messages are unable to be delivered continues or a situation where a response with respect to a question is refused continues, provision of free samples is restricted and the user is encouraged to receive email messages or respond to questions. For that reason, the purpose of dispatching email messages and the purpose of asking questions can be achieved more than in the first embodiment. That is, advertisements and free sample information can be provided to more users, and it becomes possible to accumulate ample personal information.

### (C) Other Embodiments

Various modified embodiments have been referred to in the description of each of the preceding embodiments, but further modified embodiments exemplified below can also be given.

In the second embodiment, a case has been described where, when a situation where a user refuses to respond to a question continues, a response to an unanswered question is obtained by the free sample distributing device 2, but it may also be configured to obtain a response to an unanswered question by another method. For example, it may also be configured such that the free sample distribution information server 3 creates and dispatches an email message including the unanswered question and such that the user writes a response in an email message displayed on the mobile terminal 4 (or a personal computer) and sends that response back to the free sample distribution information server 3 so that the free sample distribution information server 3 obtains a response to the unanswered question. This method of utilizing email messages can also be applied to a case where the number of non-responses is 1 time.

Each of the preceding embodiments has been one where the user cannot designate a type of free sample with respect to the free sample distributing device 2 and obtain that free sample, but it may also be configured to accept a designation from the user with respect to some types of free samples. In this case also, it is preferable to provide other free samples for which the registered user or family fits the target demographic so as to discharge those other free samples before the free sample that has been designated (conjugated provision is preferable).

In each of the preceding embodiments, a case has been described where the free sample distribution information server 3 asks the user via the free sample distributing device 2 a question about an additional item pertaining to personal information or a question seeking feedback after use of a free sample, but it may also be configured to ask those questions with respect to the mobile terminal 4 (or personal computer) of the user. It may also be configured such that the user can input the initial personal information from the mobile terminal 4 (or personal computer).

In each of the preceding embodiments, the free sample providing company server 4 and the advertisement delivery activation server 6 have been described as being different servers, but the same server may of course be used as the free sample providing company server 5 and the advertisement delivery activation server 6.

In each of the preceding embodiments, a case has been described where all free samples for which the user who performed acquisition operation fits the target demographic are provided, but it may also be configured such that an upper limit is disposed on the number of types of free samples it offers in a single acquisition operation.

In each of the preceding embodiments, a case has been described where the free sample distribution information server 3 also dispatches the email messages, but another server may dispatch the email messages. In this case, it suffices for the free sample distribution information server 3 to supply list data of the distribution targets to the other server.

It will be noted that the disclosure of Japanese Patent Application No. 2007-182163 is incorporated by reference to its entirety in the present specification.

1. A free sample distributing system comprising:
a plurality of free sample distributing devices, each of the free sample distributing devices comprises
a housing unit that houses plural types of free samples such that they are respectively dischargeable,
a user identification information importing unit that imports, and transmits to the free sample distribution information server, identification information of a user who wants to acquire a free sample, and
a free sample providing unit that dispenses from the housing unit and supplies to the user a type of free sample that has been instructed from a free sample distribution information server, and
the free sample distribution information server comprises
a user information storing unit that stores personal information of a user to whom it is allowed to provide a free sample in association with identification information of the user,
a free sample distribution condition storing unit that stores free sample distribution conditions configured by combinations of item contents of the personal information that are determined in regard to the respective types of the free samples, and
a provided free sample type deciding unit which, when identification information of a user has been transmitted thereto from any of the free sample distributing devices, searches the user information storing unit, recognizes personal information of the user pertaining to the identification information, and compares the personal information with the free sample distribution conditions stored in the free sample distribution condition storing unit to thereby obtain a free sample distribution condition that becomes established in regard to the user, and instructs the free sample distributing device from which the identification information of the user was transmitted to provide a type of free sample pertaining to the established free sample distribution condition.

2. A free sample distribution information server that configures a free sample distributing system together with a plurality of free sample distributing devices, each of which comprises a housing unit that houses plural types of free samples such that they are respectively dischargeable, a user identification information importing unit that imports and transmits identification information of a user who wants to acquire a free sample and a free sample providing unit that dispenses from the housing unit and supplies to the user a type of free sample that has been instructed, the free sample distribution information server comprising:
a user information storing unit that stores personal information of user to whom it is allowed to provide a free sample in association with identification information of the user;
a free sample distribution condition storing unit that stores free sample distribution conditions configured by combinations of item contents of the personal information that are determined in regard to the respective types of the free samples; and
a provided free sample type deciding unit which, when identification information of a user has been transmitted thereto from any of the free sample distributing devices, searches the user information storing unit, recognizes the personal information of the user pertaining to the identification information, and compares the personal information with the free sample distribution conditions stored in the free sample distribution condition storing unit to thereby obtain a free sample distribution condition that becomes established in regard to the user, and instructs the free sample distributing device from which the identification information of the user was transmitted to provide a type of free sample pertaining to the established free sample distribution condition.

3. The free sample distribution information server according to claim 2, wherein all or some of the identification information of the user that is supplied from the free sample distributing device is biometric information of the user.

4. The free sample distribution information server according to claim 2, wherein the provided free sample type deciding unit instructs the free sample distributing device from which the identification information of the user was transmitted to provide all of the types of free samples pertaining to the established free sample distribution condition.

5. The free sample distribution information server according to claim 2, wherein the personal information of the user stored in the user information storing unit further includes information of other person around the user, and the free sample distribution conditions further use information of the other person around the user as a comparison target.

6. The free sample distribution information server according to claim 2, wherein the personal information of the user stored in the user information storing unit includes an email address, and the free sample distribution information server further comprises an email message dispatching unit that dispatches, with respect to the user who fits an email message dispatching condition configured by a combination of item contents of the personal information, an email message for free sample distribution notification or for advertisement.

7. The free sample distribution information server according to claim 6, further comprising an undelivered email message user provision restricting unit that manages a delivery status of the dispatched email message per user and restricts provision of the free sample to a user for whom there are many undelivered email messages.

8. The free sample distribution information server according to claim 2, further comprising a distribution history managing unit that manages a free sample distribution history of each user and prohibits provision of the same type of free sample to the same user at different timings.

9. The free sample distribution information server according to claim 2, further comprising
a questioning unit that asks a question via any of the free sample distributing devices in regard to an item that differs from an item when initially registering the personal information of the user in the user information storing unit, and
a personal information updating unit that updates the user information storing unit on the basis of a response with respect to the question that has been supplied from the free sample distributing device.

10. The free sample distribution information server according to claim 9, further comprising a non-response user provision restricting unit that manages the history of the response with respect to the question that has been supplied from the free sample distributing device and restricts provision of the free sample to the user for which there are many non-responses.

11. A free sample distributing device comprising:
a housing unit that houses plural types of free samples such that they are respectively dischargeable;
a user identification information importing unit that imports, and transmits to a free sample distribution information server, identification information of a user who wants to acquire a free sample;
a free sample providing unit that dispenses from the housing unit and supplies to the user a type of free sample that has been instructed from the free sample distribution information server;
a question asking unit that asks a question in regard to an item that has been instructed from the free sample distribution information server in regard to a user who is already initially registered in the free sample distribution information server; and
a responding unit that imports, and sends back to the free sample distribution information server, a response from the user with respect to the question.

12. A method of distributing a free sample in a free sample distributing system which comprises a plurality of free sample distributing devices and a free sample distribution information server, wherein
each of the free sample distributing devices comprises a housing unit that houses plural types of free samples such that they are respectively dischargeable, a user identification information importing unit, and a free sample providing unit, and
the free sample distribution information server comprises a user information storing unit that stores personal information of a user to whom it is allowed to provide a free sample in association with identification information of the users, a free sample distribution condition storing unit that stores free sample distribution conditions configured by combinations of item contents of the personal information that are determined in regard to the respective types of the free samples, and a provided free sample type deciding unit,
the method comprising:
the user identification information importing unit importing, and transmitting to the free sample distribution information server, identification information of a user who wants to acquire a free sample,
when identification information of a user has been transmitted to the provided free sample type deciding unit from any of the free sample distributing devices, the provided free sample type deciding unit searching the user information storing unit, recognizing personal information of the user pertaining to the identification information, and comparing the personal information with the free sample distribution conditions stored in the free sample distribution condition storing unit to thereby obtain a free sample distribution condition that becomes established in regard to the user, and instructing the free sample distributing device from which the identification information of the user was transmitted to provide a type of free sample pertaining to the established free sample distribution condition, and
the free sample providing unit dispensing from the housing unit and supplying to the user a type of free sample that has been instructed from the free sample distribution information server.

13. A computer-readable medium storing a program that causes free sample distribution information processing to be executed in a computer that constructs a free sample distribution information server that configures a free sample distributing system together with a plurality of free sample distributing devices, each of the plurality of free sample distributing devices comprises a housing unit that houses plural types of free samples such that they are respectively dischargeable, a user identification information importing unit that imports and transmits identification information of a user who wants to acquire a free sample, and a free sample providing unit that dispenses from the housing unit and supplies to the user a type of free sample that has been instructed, the free sample distribution information processing comprising:
storing personal information of a user to whom it is allowed to provide a free sample in association with identification information of the user;
storing free sample distribution conditions configured by combinations of item contents of the personal information that are determined in regard to the respective types of the free samples; and
when identification information of a user has been transmitted from any of the free sample distributing devices, searching the stored personal information, recognizing personal information of the user pertaining to the identification information, and comparing the personal information with the stored free sample distribution conditions to thereby obtain a free sample distribution condition that becomes established in regard to the user, and instructing the free sample distributing device from which the identification information of the user was transmitted to provide a type of free sample pertaining to the established free sample distribution condition.

14. (canceled)
